(19) United States
(12) Patent Application Publication
(10) Pub. No.: US 2008/0317637 A1
(43) Pub. Date: Dec. 25, 2008

(54) ROTATING REAGENT DISPENSER AND METHODS

(75) Inventors: Jeffrey D. Smith, Marine on St. Croix, MN (US); Bryan S. Behun, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/142,188

(22) Filed: Jun. 19, 2008

Related U.S. Application Data
(60) Provisional application No. 60/945,479, filed on Jun. 21, 2007.

(51) Int. Cl. B01L 3/00

(52) U.S. Cl. 422/99

(57) ABSTRACT

Devices and methods of dispensing and mixing reagents with samples in an enclosed container in which the amounts of the reagents dispensed into the sample are predetermined. The devices include a rotating dispenser element attached to a base, wherein an ampoule is located within a cavity in the base. The dispenser elements contain two or more dispensing chambers that are sealed and that can be opened and any reagent(s) located therein dispensed into the ampoule at selected times.

### CROSS REFERENCE TO RELATED APPLICATIONS

This application claims priority from U.S. Provisional Application Ser. No. 60/945,479, filed Jun. 21, 2007, the disclosure of which is incorporated by reference in its/their entirety herein.

### BACKGROUND

The dispensing of reagents into small volume samples (e.g., samples with a volume of about 2 milliliters or less) can be problematic. In many instances, skilled laboratory personnel are required to accurately dispense and mix reagents with collected samples. As a result, many different analyses must be performed in laboratory settings that are removed from the location at which the sample is collected (e.g., a doctor's office, hospital, etc.).

The need to transfer the samples may add to the potential for error, as samples may be misplaced, inaccurately labeled, etc. during transport. Furthermore, the remote processing of samples typically adds time and additional expense to the procedures.

In addition, even skilled laboratory personnel may occasionally dispense the wrong reagents and/or the wrong amounts of reagents into samples. In such situations, the results of any analyses performed using the reagents and the samples may be erroneous.

### SUMMARY OF THE INVENTION

The present invention provides devices and methods of dispensing and mixing reagents with samples in an enclosed container in which the amounts of the reagents dispensed into the sample are predetermined.

It may be preferred that a device of the present invention include a rotating dispenser element attached to a base, wherein an ampoule is located within a cavity in the base. The dispenser elements may preferably contain two or more dispensing chambers that are sealed and that can be opened and any reagent(s) located therein dispensed into an ampoule at selected times. The dispenser element rotates about an axis that extends through the top and bottom of the base, and rotation of the dispenser element relative to the base brings each dispensing chamber of the plurality of dispensing chambers into a position over the inlet of the ampoule. The dispenser element and the base preferably include an alignment mechanism with a plurality of defined positions between the dispenser element and the base. Each defined position preferably places one dispensing chamber of the plurality of dispensing chambers in alignment with the inlet of the ampoule. When the axis is aligned with the force vector of gravity and the dispenser element and the base are in one of the defined positions, and the device is oriented such that the aligned dispensing chamber is located above the inlet of the ampoule, reagent dispensed from the one aligned dispensing chamber falls under the force of gravity into the ampoule.

The different dispensing chambers in the dispenser element may contain the same or different reagents. It may be preferred that the dispensing operation be capable of manual actuation, i.e., it may be preferred that a user may use finger pressure to open and dispense reagents contained in the dispensing chambers.

The use of sealed dispensing chambers containing reagents can provide greater efficiency, less sample contamination, less sample loss through transfer, better stability, and longer shelf life.

As used herein, the term “reagent” (and variations thereof) may include any substance that may be useful in performing one or more different tests, assays, etc. on test samples deposited into the devices of the invention. Examples of some potentially suitable reagents may include, but are not limited to, any liquid (e.g., water, saline, alcohol, organic solvents, etc.), neutralizing agents (e.g., a buffer to adjust pH, a material to block or inhibit nuclease, enzyme substrates such as a protein to neutralize an enzyme activity, etc.), digesting agents that depolymerize other materials (e.g., chemical or enzymatic agents to dissolve mucous, proteases to break down proteins, glycosidases to break down complex carbohydrates, lipases, nucleases, etc.), lytic agents to lyse or permeabilize target cells (e.g., lysozyme, lysostaphin and protease K, phospholipases, organic solvents, etc.), buffers, mucolytic agents (such as enzymes, salts, solubilizing agents (e.g., surfactants, detergents, etc.), reducing agents, acids, etc.), labeling agents (e.g., reactant molecules for analyte binding such as antibodies, lectins, enzymes, and receptors and other binding pair technologies, as well as other reactant molecules that recognize metabolic by-products (e.g., pH changes, detectable enzyme production)), etc.

In one aspect, the present invention may provide a reagent dispenser device that includes a base having a top, a bottom and a sidewall extending between the top and bottom, wherein the base further includes a cavity formed in the sidewall; an ampoule located within the cavity, wherein the ampoule has an inlet and a cap, and wherein the ampoule defines a closed volume when the cap closes the inlet of the ampoule; and a dispenser element attached to the top of the base, wherein the dispenser element includes a plurality of dispensing chambers, wherein each of the dispensing chambers has a volume containing a reagent in an enclosed volume. The dispenser element is rotatably attached to the base, wherein the dispenser element rotates about an axis that extends through the top and bottom of the base, and wherein rotation of the dispenser element relative to the base brings each dispensing chamber of the plurality of dispensing chambers into a position over the inlet of the ampoule. The dispenser element and the base may include an alignment mechanism with a plurality of defined positions between the dispenser element and the base, wherein each defined position is a position wherein one dispensing chamber of the plurality of dispensing chambers is aligned with the inlet of the ampoule. When the axis is aligned with the force vector of gravity, the dispenser element and the base are in one of the defined positions, and the device is oriented such that the aligned dispensing chamber is located above the inlet of the ampoule, reagent dispensed from the one aligned dispensing chamber falls under the force of gravity into the ampoule.

In other aspects, the present invention may include one or more of the following features: the cavity may extend from the top of the base towards the bottom of the base, and wherein the dispenser element includes an access port, wherein one of the defined positions between the dispenser element and the base includes a defined position in which the access port of the dispenser element is aligned with the cavity, wherein the inlet of the ampoule is not covered by the dispenser element; the cap may be attached to the ampoule when the ampoule is in the cavity and the inlet is not closed by the cap; the cap may include a snap-fit attachment over the inlet of the ampoule when the cap is attached over the inlet of the ampoule; the cap may include a threaded connection to the ampoule when the cap is attached over the inlet of the ampoule; the cap may include a frangible seal through which the closed volume is accessible when the cap closes the inlet of the ampoule; the cap may include a self-sealing septum; etc.

In another aspect, the present invention may include a method of dispensing one or more reagents into a test sample using a reagent dispenser device as described herein, the method including depositing a test sample into the ampoule of the reagent dispenser; rotating the dispenser element relative to the base; and dispensing a reagent from one dispensing chamber of the plurality of dispensing chambers into the ampoule.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a cap or ampoule that includes a reagent can include one or more reagents.

The term “and/or” means one or all of the listed elements or a combination of any two or more of the listed elements.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the views of the drawing, wherein:

FIGS. 1 & 2 are perspective views of one exemplary device according to the present invention.

FIG. 3 is a cross-sectional view of one dispensing chamber that may be used in the devices of the invention.

### DETAILED DESCRIPTION OF EXEMPLARY EMBODIMENTS

The present invention relates generally to reagent dispensing devices and, more particularly, to rotating reagent dispensers and methods of using the same.

In the following detailed description of exemplary embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

Operation of the devices of the present invention may preferably rely on gravitational forces and orientation of the devices of the invention relative to those gravitational forces. As used herein, “gravity” (and its force vectors—where a force vector is indicative of the direction of the gravitational force on an object) may be real or apparent. Apparent gravity can be generated by, e.g., spinning the device such that centrifugal forces provide the apparent gravitational forces used to move materials in the devices.

Because the devices of the present invention are preferably designed to rely on gravitational forces (real or apparent), the orientation of the components in devices of the invention may be described as “above” or “below” other components. Any such terms should be understood as indicating position relative to the gravitational forces (i.e., the force vectors) acting on the device with the gravitational force tending to move materials in what is referred to as a downward direction. In other words, a component identified as being located “above” another component is located in a direction that is opposite the force vector of gravity while a component that is identified as being “below” another component is located in a direction that is the same as the force vector of gravity.

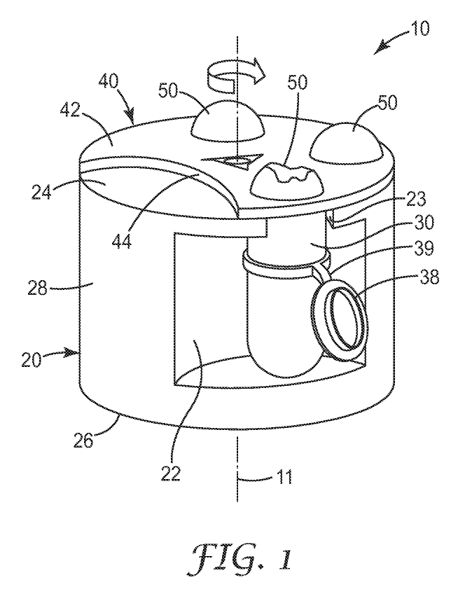

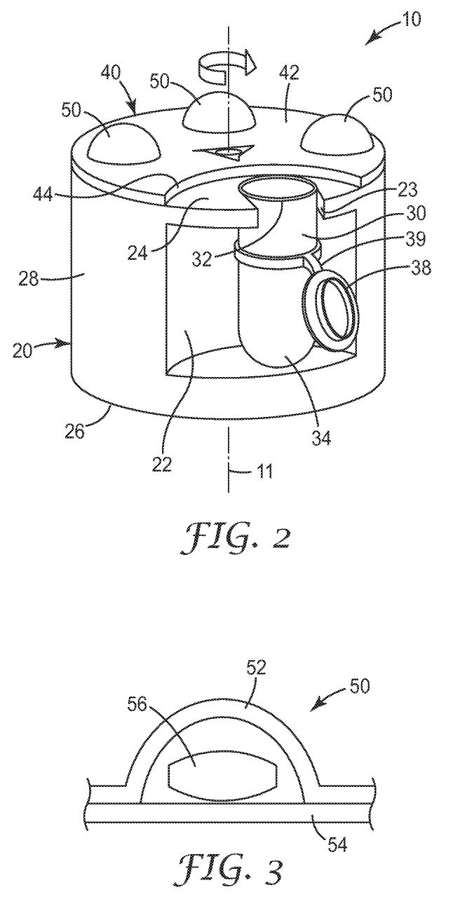

One exemplary device 10 according to the present invention is depicted in the perspective views of FIGS. 1 & 2 as well as the cross-sectional view of FIG. 3. The device 10 includes a base 20, an ampoule 30 is located within a cavity 22 formed in the base 20, a dispenser element 40 attached to the base 20, and dispensing chambers 50 in the dispenser element 40.

It may be preferred that the material or materials used to construct the ampoules 30 and the dispensing chambers 50 (or at least the portions of those components that will contact the sample and/or reagents) be non-reactive with the sample and/or reagents. Examples of some potentially suitable polymeric materials that could be used in many different applications may include, but are not limited to, polycarbonate, polypropylene (e.g., isotactic polypropylene), polyethylene, polyester, etc. Other materials such as, e.g., glass, silicon, etc. may also be used for at least portions of some devices.

It may be preferred that the base 20 and the ampoule 30 be provided as separate and discrete articles, with the base 20 including retaining structure within the cavity 22 that functions to retain the ampoule 30 within the cavity 22 until a user decides to remove the ampoule 30 from the cavity 22. The retaining structure may rely on any suitable technique or combination of techniques to retain an ampoule in the cavity 22. Examples of some potentially suitable techniques may include, e.g., clips, adhesives, interlocking mechanical connectors, magnets, etc.

The ampoule 30 includes an inlet 32 and a collection well 34 that is preferably located opposite from the inlet 32. The collection well 34 may preferably have a rounded shape to assist with collecting and concentrating any sample and reagents delivered to the ampoule 30 in as small of a volume as possible.

The body portion of the depicted ampoule 30 (where the body is that portion located between the collection well 34 and the inlet 32) may have a uniform cross-sectional area as depicted in FIGS. 1 & 2 in which the wall forms a right circular cylinder. It should be understood, however, that the ampoule 30 may take many other alternative shapes, e.g., the cross-sectional area of the body of the ampoule 30 may decrease when moving from the inlet 32 to the collection well 34, the body may be formed as a hexagonal or other non-circular tube, etc. Furthermore, in some instances, the collection well 34 may be located in direct communication with the inlet 32, i.e., the wall may be shortened or even non-existent in some embodiments of ampoules used in connection with the present invention.

The ampoule 30 may preferably include a cap 38 adapted to close the inlet 32 of the ampoule 30 such that the ampoule 30 defines an enclosed volume in which any sample material and reagents dispensed therein may be retained. The cap 38 may preferably be attached over the inlet 32 of the ampoule 30 by any suitable technique. For example, the inlet 32 may include a protruding lip while the cap 38 forms a snap-fit connection over the lip of the inlet 32. Other potentially suitable techniques for attaching the cap 38 to the ampoule 30 in a manner that closes the inlet 32 to define an enclosed volume may include, e.g., a threaded connection, adhesives, a friction fit, etc.

The cap 38 may preferably be attached to the ampoule 30 even when the cap 38 is not in a position on the ampoule 30 in which it closes the inlet 32. In the depicted embodiment, the cap 38 is attached to ampoule 30 by a tether 39 although any other suitable attachment technique (e.g., adhesives, etc.) could be used in place of the tether 39.

In some embodiments, the cap 38 may include a frangible seal through which the enclosed volume of the ampoule 30 is accessible even when the cap 38 closes inlet 32 of the ampoule 30. Access to the enclosed volume of the ampoule 30 may be used to deliver additional materials (e.g., sample, reagents, etc.) to the ampoule 30 or to remove materials from within the ampoule 30. The frangible seal may be provided in the form of, e.g., a polymer film, metallic foil, composite polymer film/metallic foil, etc., that may be punctured, pierced, etc. to gain access to the interior volume of the device.

In still other embodiments, the cap 38 may include a resealable member through which access may be obtained to the enclosed volume of the ampoule 30 when the cap 38 is attached over the inlet 32. The resealable member may provide a location through which materials may be delivered into or removed from the ampoule 30. The resealable member (e.g., septum, etc.) may preferably allow the insertion of a fluid transport device (e.g., pipette, needle, etc.) to access the enclosed volume of the ampoule 30, but reseal or close after removal of the fluid delivery device.

The frangible seals and resealable members described herein with respect to the cap 38 may alternatively be provided as a part of the ampoule 30, i.e., these components may not necessarily be located in the cap 38.

In the depicted embodiment of device 10, the base 20 includes a top 24 and a bottom 26, with a sidewall 28 extending between the top 24 and the bottom 26. Although the base 20 is depicted as having a generally circular shape, the base 20 may alternatively have other shapes, e.g., hexagonal, square, elliptical, etc.

As depicted, the ampoule 30 may be located within a cavity 22 that is formed into the sidewall 28 of the base 20. The cavity 22 may include a slot 23 into which the inlet 32 of the ampoule 30 is fitted. The slot 23 may be helpful in both aligning the inlet 32 of the ampoule 30 in a selected location as well as retaining the ampoule 30 within the cavity 22. In addition, although the base 20 is depicted as including a single continuous sidewall 28 because the top 24 and bottom 26 of the base 20 are circular, the bases of the present invention may include more than one sidewall to, e.g., connect a square bottom to a circular top.

The device of the present invention also includes a rotating dispenser element 40 and dispensing chambers 50 that, in the depicted embodiment, may be provided in the form of modules that are separate and discrete from the dispenser element 40. The dispensing chambers 50 may be used to provide reagents that can be dispensed into the ampoule 30 when the dispenser element 40 is positioned such that one of the dispensing chambers 50 is located above the inlet 32 of the ampoule 30.

Rotation of the base 20 and the dispenser element 40 relative to each other preferably takes place about an axis 11 that extends through the base 20 and the dispenser element 40. Although the base 20 and the dispenser element 40 in the depicted embodiment are both formed as right circular cylinders, the base 20 and the dispenser element 40 may take any suitable shape or shapes that allow for relative rotation between the two components. Also, although the exemplary embodiments described herein may be described as involving rotation of the dispenser element 40 (which implies that the base 20 is stationary), the device may be operated by holding the dispenser element 40 stationary while rotating the base 20 or by rotating both the base 20 and the dispenser element 40 at the same time.

Rotation of the dispenser element 40 preferably moves one or more of the dispensing chambers 50 into alignment above the inlet 32 of the ampoule 30 (as depicted in, e.g., FIG. 1). It may be preferred that the base 20 and the dispenser element 40 include an alignment mechanism that provides defined positions between the dispenser element 40 and the base 20. At least some of those defined positions preferably include arrangements in which one of the dispensing chambers 50 is in alignment with the inlet 32 of the ampoule 30.

When one of the dispensing chambers 50 is in alignment with the inlet 32 of the ampoule 30 and the axis 11 of the device 10 is aligned with the force vector of gravity such that the inlet 32 is located below the aligned dispensing chamber 50 (see, e.g., FIG. 1), reagent dispensed from the aligned dispensing chamber 50 preferably falls under the force of gravity into the ampoule 30.

Although it may be preferred that the alignment mechanism include at least one defined position for each of the dispensing chambers 50 in which each dispensing chamber 50 is positioned in alignment with the inlet 32 of the ampoule 30, other defined positions may also be provided in which none of the dispensing chambers 50 is aligned above the inlet 32 of the ampoule 30.

The alignment mechanism may take many different forms, e.g., a detent mechanism (with protrusions/pins and complementary recesses), similarly shaped dispenser elements and bases (e.g., if both are shaped with a corresponding number of sides (such as four, five, etc.), then alignment of the dispenser element 40 on the base would be possible; etc.).

The dispenser element 40 may preferably include a main body 42 positioned over the base 20 and an access port 44 formed in the main body 42 of the dispenser element 40. The access port 44 of the dispenser element 40 is preferably provided as a cutout in which the main body 42 is not present such that when the access port 44 is positioned over the inlet 32 of the ampoule 30, the inlet 32 of the ampoule 30 is not covered by the main body 42 of the dispenser element 40 (as depicted in FIG. 2). Although this implies that the reminder of the main body 42 covers the inlet 32 of the ampoule 30 in all other positions, such a construction may not be required. It may, however, be preferred that the main body 42 of the dispenser element 40 cover the inlet 32 of the ampoule 30 in all other positions because such a construction may reduce or prevent unwanted materials (e.g., dirt, etc.) from entering the ampoule 30.

Although the access port 44 is depicted as a cutout in the exemplary embodiment, other variations are possible. For example, the access port may be formed as a portion of the main body 42 that is removed, e.g., using hinges, tear lines, etc. to provide access to the inlet 32 of the ampoule 30.

Although the dispenser element 40 in the depicted embodiment includes four dispensing chambers 50, it should be understood that the devices of the invention may include as few as two dispensing chambers, three dispensing chambers, four dispensing chambers (as depicted), or five or more dispensing chambers.

The dispensing chambers 50 may, as described herein, be provided in the form of discrete modules attached to the dispenser element 40. Alternatively, the dispensing chambers 50 may be provided as integral components of the dispenser element 40. In any embodiment, it may be preferred that each of the dispensing chambers 50 includes a volume in which one or more reagents are located before being dispensed. It may be preferred that the volumes of the dispensing chambers 50 be sealed volumes such that the shelf-life of any reagents located therein may be increased.

It may be preferred that the dispensing chambers 50 be formed as “blister-packs” in which one side of the chamber is deformed to force any reagent located therein through an opposing side of the dispensing chamber. One exemplary dispensing chamber 50 is depicted in the cross-sectional view of FIG. 3. It may be preferred that a first side 52 of the dispensing chamber 50 be formed in a raised shape (e.g., a dome) such that deformation of the first side in the dispensing operation flattens or even inverts the first side. The first side 52 of the dispensing chambers in such embodiments may preferably be formed of materials that are suitable for deformation, e.g., polymers, metallic foils, woven materials, knitted materials, nonwoven materials, etc. and combinations thereof. The selection of specific materials may be based on a variety of factors including compatibility with the reagents and sample materials, manufacturability, etc.

The second side 54 of the dispensing chamber 50 (i.e., the side opposite the first side) may preferably be manufactured of materials that will rupture or tear when desired, e.g., polymer films, metallic foils, woven materials, knitted materials, nonwoven materials, etc. and combinations thereof. One example may be a polymer film/metallic foil laminate. The selection of specific materials may be based on a variety of factors including compatibility with the reagents and sample materials, manufacturability, etc.

The materials used to construct the dispensing chambers may preferably be amenable to the sealing required to contain any reagents therein. For example, the materials used to construct first side 52 and second side 54 of the dispensing chambers 50 may be suitable for heat sealing, solvent welding, ultrasonic bonding, adhesive attachment, etc.

Although the dispensing chambers 50 may be provided as discrete modules that can be located within apertures in the dispenser element 40, they may alternatively be provided in an integral construction in which at least one side of the dispensing chamber 50 is formed integrally with the dispenser element 40 while the other side is then attached to the dispenser element 40 using an appropriate attachment technique (or techniques) that provide the desired level of containment for any reagent located in the dispensing chamber 50.

It may be preferred that one or both sides of the dispensing chambers 50 include features to assist in dispensing of any reagents located therein. One example of such a feature may be a post or other structure protruding from the inner surface of the first side of the dispensing chamber 50. The post or other structure may preferably act as a force concentrator to assist in opening the second side of the dispensing chamber 50 when the first side is pressed against the second side to dispense any reagents located in the dispensing chamber 50. Other features that may be used to assist in dispensing materials from the dispensing chambers 50 may include, e.g., lines of weakness formed in the second side where the second side may preferentially separate along the line of weakness. Lines of weakness may be formed by, e.g., thinning the second layer along a selected line, perforating one or more layers provided in the second side, etc. Examples of some potentially suitable dispensing chamber constructions may be described in, e.g., U.S. Pat. Nos. 3,326,363; 3,796,813; 4,785,931; 5,035,320; etc.

As discussed herein, the dispensing chamber 50 may preferably be used to dispense one or more reagents 56 (see FIG. 3) into the ampoule 30 at a selected time. The reagents may be in any suitable form, e.g., liquids, powders, granules, tablets, etc. and combinations thereof. It may be preferred that any reagents located in the dispensing chambers release consistently and completely from the dispensing chambers.

As discussed herein, some devices 10 may include dispensing chambers 50 in which each of the dispensing chambers contain different reagents. Alternatively, two or more dispensing chambers 50 may contain the same reagent (or combination of reagents), thus providing a user with the ability to dispense the same reagent at different times.

The devices of the present invention may be used to perform a wide variety of test and/or sample preparation processes. With reference to the depicted embodiment, a test sample may be delivered to the ampoule 30 by any suitable technique, e.g., pipette, swab, etc. In some instances, the test sample may be delivered to the ampoule 30 before the ampoule 30 is attached to the device 10. In other instances, the test sample may be delivered into the ampoule 30 after the ampoule 30 is already attached to the device 10.

With the test sample in the ampoule 30, the reagents contained within the dispensing chambers 50 may be dispensed into the ampoule 30 in any selected order and at any selected time depending on the protocol of the test/sample preparation procedure to be performed on the test sample. Because the dispensing chambers can be opened to release their contents at any selected time, a variety of actions may be performed between dispensing operations. For example, the test sample (and any reagents already dispensed into the test sample) may be heated, cooled, vortexed, agitated, etc. between or after all of the reagents in the dispensing chambers 50 have been released into the ampoule 30.

At any selected time, the test sample (and any previously dispensed reagents) may be removed from the ampoule 30 in whole or in part. Removal of materials from the ampoule 30 may be performed by, e.g., positioning the access port 44 of the dispenser element 40 into alignment over the inlet 32 of the ampoule 30 (as discussed herein), or, in some instances, by piercing a frangible seal or resealable member (e.g., septum, etc.) that may be located in, e.g., a cap.

The devices and methods of the present invention may be used to analyze and/or prepare a test sample for further analysis where the test sample contains a microorganism or other biological material of interest, although certain devices and methods of the present invention have broader applicability with respect to the test sample and the subsequent use of the test sample.

The test sample may be derived from a variety of sources, such as a physiological fluid, e.g., mucous, blood, saliva, ocular lens fluid, synovial fluid, cerebral spinal fluid, pus, sweat, exudate, urine, lactation milk, or the like. Further, the test sample may be derived from a body site, e.g., wound, skin, nares, scalp, nails, etc. Besides physiological fluids, other test samples may include other liquids as well as solid(s) dissolved in a liquid medium. Samples of interest may include process streams, water, soil, plants or other vegetation, air, surfaces (e.g., contaminated surfaces), and the like.

Further information with regard to some potential tests, reagents, and purposes for the devices of the present invention may be found in, e.g., U.S. Provisional Patent Application Ser. No. 60/867,012, titled SYSTEMS AND METHODS FOR SAMPLE PREPARATION USING CAPS AND AMPOULES and PCT Application Serial No. PCT/US2007/085242, titled SYSTEMS AND METHODS FOR PREPARING AND ANALYZING SAMPLES.

The complete disclosure of the patents, patent documents, and publications cited herein are incorporated by reference in their entirety as if each were individually incorporated.

Exemplary embodiments of this invention have been discussed and reference has been made to possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A reagent dispenser device comprising:
a base comprising a top, a bottom and a sidewall extending between the top and bottom, wherein the base further comprises a cavity formed in the sidewall;
an ampoule located within the cavity, wherein the ampoule comprises an inlet and a cap, and wherein the ampoule defines a closed volume when the cap closes the inlet of the ampoule; and
a dispenser element attached to the top of the base, wherein the dispenser element comprises a plurality of dispensing chambers, wherein each of the dispensing chambers comprises a volume containing a reagent in an enclosed volume;
wherein the dispenser element is rotatably attached to the base, wherein the dispenser element rotates about an axis that extends through the top and bottom of the base, and wherein rotation of the dispenser element relative to the base brings each dispensing chamber of the plurality of dispensing chambers into a position over the inlet of the ampoule;
wherein the dispenser element and the base comprise an alignment mechanism comprising a plurality of defined positions between the dispenser element and the base, wherein each defined position comprises a position wherein one dispensing chamber of the plurality of dispensing chambers is aligned with the inlet of the ampoule;
and wherein, when the axis is aligned with the force vector of gravity, the dispenser element and the base are in one of the defined positions, and the device is oriented such that the aligned dispensing chamber is located above the inlet of the ampoule, reagent dispensed from the one aligned dispensing chamber falls under the force of gravity into the ampoule.

2. A device according to claim 1, wherein the cavity extends from the top of the base towards the bottom of the base, and wherein the dispenser element comprises an access port, wherein one of the defined positions between the dispenser element and the base comprises a defined position in which the access port of the dispenser element is aligned with the cavity, wherein the inlet of the ampoule is not covered by the dispenser element.

3. A device according to claim 1, wherein the cap is attached to the ampoule when the ampoule is in the cavity and the inlet is not closed by the cap.

4. A device according to claim 1, wherein the cap comprises a snap-fit attachment over the inlet of the ampoule when the cap is attached over the inlet of the ampoule.

5. A device according to claim 1, wherein the cap comprises a threaded connection to the ampoule when the cap is attached over the inlet of the ampoule.

6. A device according to claim 1, wherein the cap comprises a frangible seal through which the closed volume is accessible when the cap closes the inlet of the ampoule.

7. A device according to claim 1, wherein the cap comprises a self-sealing septum.

8. A method of dispensing one or more reagents into a test sample, the method comprising:
providing a reagent dispenser according to claim 1;
depositing a test sample into the ampoule of the reagent dispenser;
rotating the dispenser element relative to the base; and
dispensing a reagent from one dispensing chamber of the plurality of dispensing chambers into the ampoule.
